(19) United States
(12) Patent Application Publication
(10) Pub. No.: US 2009/0167756 A1
(43) Pub. Date: Jul. 2, 2009

(54) METHOD AND APPARATUS FOR COMPUTATION OF WIRELESS SIGNAL DIFFRACTION IN A THREE-DIMENSIONAL SPACE

(75) Inventors: Alexander Bijamov, Plantation, FL (US); Celestino Corral, Ocala, FL (US); Salvador Sibecas, Lake Worth, FL (US); Glafkos Stratis, Lake Worth, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/967,426

(22) Filed: Dec. 31, 2007

(51) Int. Cl. G06T 1/00

(52) U.S. Cl. 345/419

(57) ABSTRACT

A method (20 or 500) and system (200) for method for computing wireless signal diffraction in a three-dimensional space can include the steps of selecting at least a source point, finding (19) sinkpoints that fail to have a line-of-sight path to the source point and storing the sinkpoints found, placing (21) diffraction points on all edges of a three-dimensional geometry, and building (24) a visibility matrix based on weighted paths for all source points and all sink points. The method can further include applying (25) a path finding algorithm on the visibility matrix for each sink point to all source points and storing store optimal paths for each source point to all sink points if they exist. The method can further include determining (23) if a last source point is selected before building the visibility matrix.

### FIELD

This invention relates generally to determining three-dimensional diffraction paths, and more particularly to determining three-dimensional diffraction paths to enhance ray tracing for propagation simulating for wireless communication systems.

### BACKGROUND

Determining diffraction in an arbitrary three-dimensional space is a complex problem. When the size of a scene and frequencies employed satisfy certain criteria, asymptotic methods such as geometrical or uniform theory of diffraction (GTD or UTD) can be used. An essential part of these approaches is the creation of so called “diffraction paths'” and determining corresponding diffraction points. These methods describe diffraction on the angular edge, possibly with the presence of multiple edges nearby. A complete solution would require accounting for all possible scatterers and thus making such a solution virtually impossible due to the enormous computational resources required. However, it is usually enough to account for the most significant scatterers only to obtain acceptable accuracy.

Algorithmic techniques have been proposed for solving problems which can be collapsed into a 2-D representation. For example, in simulating “over-the-roof” diffraction, a simulated base point is placed far below the rooftop. Paths from source (transmitter) to sink (receivers) are then traced taking advantage of the fact that only the sky is above the roofs and therefore only those edges encountered during the path are valid over-the-roof edges, thus allowing to employ fast convex hull algorithms. Over-the-roof diffraction is particularly important because it has been asserted that long-range wireless propagation typically occurs over the rooftops.

To account for more general cases, including around-the-side diffraction, a “crawling” approach is typically employed whereby a ray is traced out from the source to the sink, and if obstructed, crawls along the obstruction until it encounters the edge. The ray is then traced from this new point to the sink and if obstructed, crawling along the new obstruction proceeds. The process is repeated until all possible diffraction paths are accounted for and is fairly efficient in a 2-D plane, although it is necessary to “backtrack” and eliminate paths which are replaced by others. Extension to a 3-D case is possible, although it is recognized that the computational load can become unduly extensive. Thus, current techniques for determining three-dimensional diffraction paths are unsatisfactory from a practical standpoint.

### SUMMARY

Embodiments in accordance with the present invention can provide a method and system for determining optimal and full three-dimensional diffraction paths for the purposes of simulating a wireless communication system using deterministic analysis. The accuracy of the technique can be set to an arbitrary level and can be used with a 3-D propagation analysis tool.

In a first embodiment of the present invention, a method for computing wireless signal diffraction in a three-dimensional space can include the steps of selecting at least a source point, finding sinkpoints that fail to have a line-of-sight path to the source point and storing the sinkpoints found, placing diffraction points on all edges of a three-dimensional geometry, and building a visibility matrix based on weighted paths for all source points and all sink points. The method can further include the steps of applying a special path finding algorithm on the visibility matrix for each sink point to all source points and storing optimal paths for each source point to all sink points if they exist. The method can further include the step of determining if a last source point is selected before building the visibility matrix. The method can also include the step of finding all points visible to a current source point and storing the points visible and further keeping an index to the source point where the current source point is deemed a first generation. The method can further include picking a next point from a list of points in a current generation and determining if a next picked point in the list of points is a last point and if so incrementing the current generation. If a last generation is determined, then the method can apply weights based on a desired metric to a path defined by a previous generation point and current generation point. If the last generation has failed to be reached, then the method can get a list of points from the current generation. The method can further include determining if a next picked point in the list of points is a last point and if not, determining if the next picked point in the list of points is in line-of-sight to a sink point. The method can store all sink points with line of sight to the current source point until all sink points with the path are determined. The method can also find all points visible to the current source point and storing all points visible while keeping the index to the current point. The method can further apply weights based on a desired metric to a path defined by a previous generation point and a current generation point. The method can further control a number of diffractions by limiting a maximum number of generations of points.

In a second embodiment of the present invention, a computer program can be embodied in a computer storage medium and operable in a data processing machine for computing wireless signal diffraction in a three-dimensional space. The data processing machine can further be operable to function as otherwise previously described with the first embodiment described above.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. A “source point” is general thought of as the source of a signal such as a transmitter. A “sink point” is generally considered the receiver of the signal from the source point. “Diffractions points” are points where measurements can begin for signal energy behind an obstruction. “Line-of-sight” generally refers to a direct unobstructed view between two points. A “visibility matrix” can mean a matrix construct that contains the visibility information of the vertices of a path including weighting information and direction designators as might be used by an algorithm for simulating diffractions paths in 3-D. “Weighted paths” are paths that are adjusted for other factors considered in a particular path finding algorithm. A “first generation” generally means the source point in the context of the embodiments herein.

The terms “program,” “software application,” “resizing program” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a representation of candidate diffraction paths where the number of candidate diffraction points observable from the current generation point are limited in accordance with an embodiment of the present invention.

FIG. 2 is a first portion of a flow chart illustrating a method for computation of wireless signal diffraction in a three-dimensional space in accordance with an embodiment of the present invention.

FIG. 3 is a second portion of a flow chart illustrating the method for computation of wireless signal diffraction in a three-dimensional space in accordance with an embodiment of the present invention.

FIG. 4 is a third portion of a flow chart illustrating the method for computation of wireless signal diffraction in a three-dimensional space in accordance with an embodiment of the present invention.

FIG. 5 is a wireless device that can deployed in an area being simulated in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of ways using a variety of methods that can efficiently simulate diffraction effects for a wireless communication system. Diffraction is an important phenomenon in wireless communications. Diffraction is generally known as the bending, spreading and interference of waves when they meet an obstruction or gap. In wireless communication, diffraction allows for the reception of signal energy behind obstructions in the so-called “shadow” region. These diffraction problems are electrically large so there are strict demands to the computational method. It is most apparent in cellular systems with transmitter antennas on the top of high buildings where the diffracted energy reaches a subscriber below the rooftop. Thus, simulating diffraction effects and determining a generalized approach for treating all types of diffraction phenomena is important for successful deployment and operation of wireless systems.

An implementation of diffraction paths in a 3-D space can have several implementation constraints. Referring to the flow chart and method 20 of FIG. 2, an embodiment herein can determine three-dimensional diffraction paths to enhance ray tracing for propagation simulating for wireless communication systems. For example, the derivation of a generalized technique should exploit existing approaches where possible (but not necessarily). Indeed, it is important to evaluate the potential of known algorithms in order to leverage existing techniques and enable a rapid development or implementation. The determination of diffraction paths in a 3-D space can benefit from well-known path searching algorithms including depth-first search, breadth-first search, and Dijkstra's path finding technique. The latter, in particular, allows for the weighting of the paths (these paths being directional or not) and determines the lowest-cost path. If this optimum approach is utilized with the proper weighting of the path arcs, then it is possible to obtain the optimal diffraction path in a 3-D environment.

In one particular embodiment, a method 20 as illustrated in the flow chart of FIG. 2 can include a first step to determine a potential diffraction point candidate such as finding sink points that do not have line-of-sight paths to a source point as in step 19. These steps can further include:
1. Obtain all edges from the geometry with corresponding polygons and directions and placing diffraction points on all edges of the 3-D geometry as shown in step 21.
2. Remove all edges which are between coplanar polygons. This effectively results in a flat polygonal surface with edges only between the outer vertices.
3. Create the list of potential diffraction points. The list shall contain parameter ρ—where ρ is used for determining the location of the diffraction point along the edge—and the edge information, thus

P=P₁+ρ(P₂−P₁) (1)
where P₁ and P₂ are the endpoints of the edge. Once this is done for one source point, a next source point can be chosen at step 22.

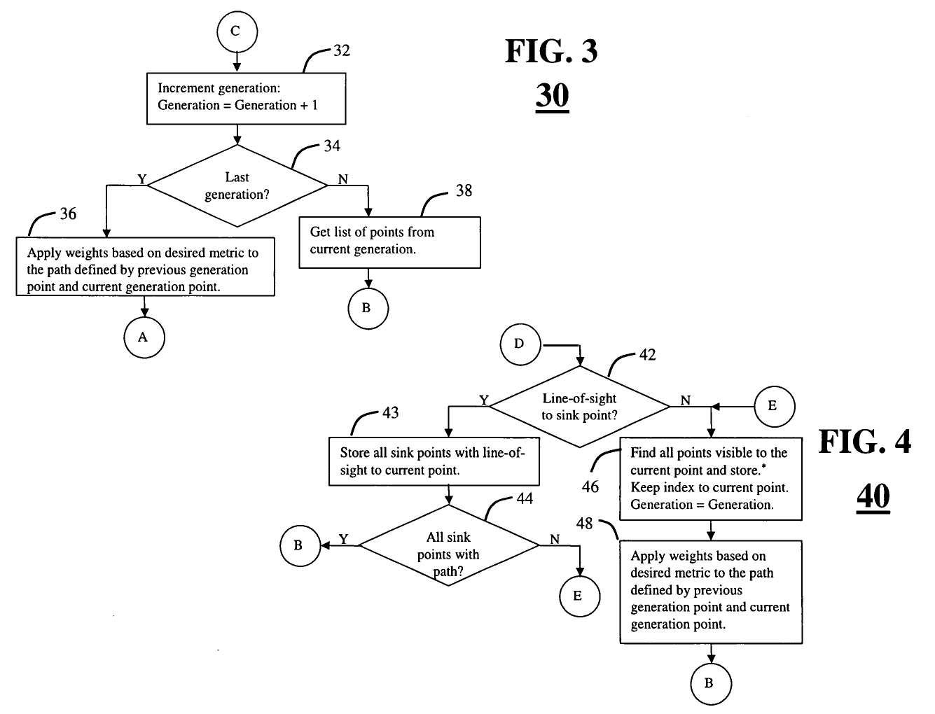

The next step is to build the so-called visibility graph. The visibility graph is a matrix construct that contains the visibility information of the vertices of the path along with the weights and direction designators as needed by the algorithm at step 24. The construction of a visibility matrix is an important element for the successful and optimal implementation of several embodiments herein. The process is as follows:
1. Select signal reception points (or sinks) that do not have line-of-sight with the signal source point.
2. Start from the source point.
3. Generate the visibility graph based on the diffraction points that are visible to other diffraction points. This is handled through the concept of generation as described in the following:
   a. Source point is generation 1.
   b. All diffraction point candidates visible to the source point make generation 1 as illustrated in step 27.
   c. All diffraction point candidates visible from generation N, other than those belonging to generations 1 through N, become generation N+1 as illustrated by step 32 in FIG. 3 of a method portion 30.
   d. Stop searching at decision step 34 when a specified maximum number of generations is reached. (Alternatively, stop searching if the visibility graph is too large in memory.)
   e. During build of generation 1 (excluding the source point) and all subsequent generations, check for line-of-sight from the candidate diffraction points of that generation to the sink points.

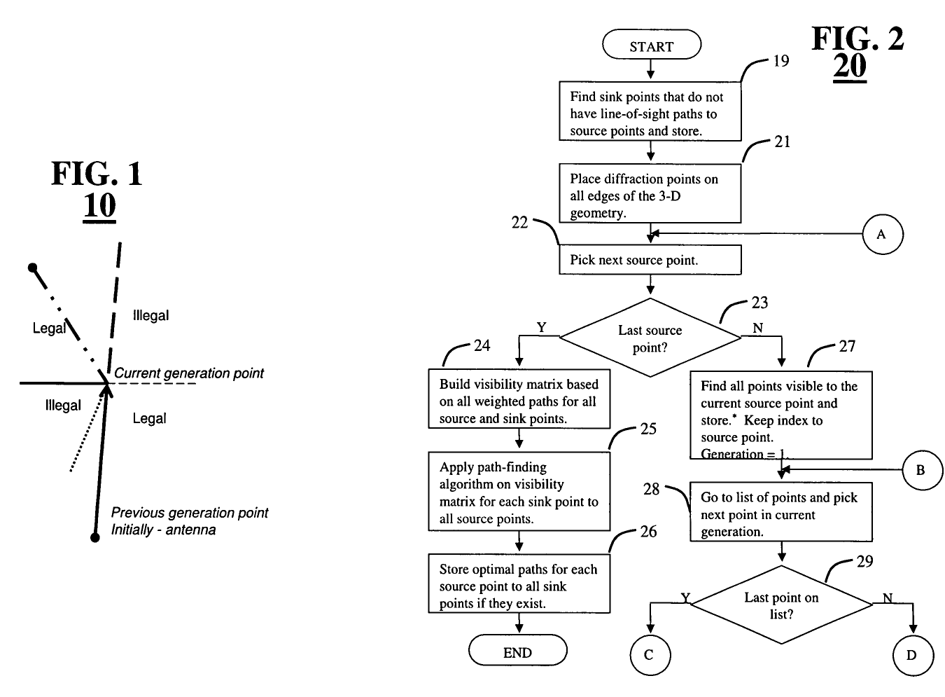

To significantly minimize the number of candidate diffraction points (and therefore the size of the visibility graph), some basic assumptions are made. First, it is noted that diffraction must bend “inward,” that is, the diffraction angle relative to an edge must not be greater than 180° as shown in FIG. 1. This effectively designates a region that excludes candidate diffraction points from the current generation (denoted as the illegal region in FIG. 1). This can result in a significant reduction in the number of candidate diffraction points to include in a next generation of points. A simpler scheme is implemented in Motorola's MotoWavez product, whereby the edge adjacent to the diffraction path is extended out instead of the actual diffraction path angle.

Second, the Uniform Theory of Diffraction or UTD algorithm requires that incoming and outgoing path segments' angles with the edge be the same. This condition helps filter significant amounts of visible but invalid diffraction paths and significantly reduces the visibility graph size and computation times.

To support this capability, each diffraction candidate point in a current generation must hold a reference to the corresponding previous generation point. The space in which the next candidate diffraction point can be located for the visibility graph is defined by the farthest facet plane (thick horizontal line in FIG. 1) and the line from the previous point to the current point (almost vertical line in FIG. 1). In addition, the incoming angle, defined by the receiving edge bounding the facet planes (dashed line in the lower left quadrant and the dashed horizontal line in FIG. 1) are also allowed for searching the next generation of candidate diffraction points.

The final step is weights the path elements appropriately such that the path finding algorithm determines an optimal path (see step 36 of method portion 30 of FIG. 3 or step 48 of method portion 40 of FIG. 4). The rules for weighting the paths can include:
Weight for all edges, except those that include either the source or the sink points, shall be an appropriate metric. An initial metric may be just the 3-D distance between the points. The weight can also be adjusted by the actual power of the signal along the path, this power can be calculated using the normals of the edges relative to diffraction paths and the antenna gains at each point.
For the path from the source to the first diffraction point, or the path from the last diffraction point to the sink, the weight can be multiplied by a factor, where this factor can depend upon:
   Antenna pattern orientation at the source/sink.
   The polarization of the wave at the source or sink in relation to the next edge orientation.

Once the visibility graph is constructed, it is possible to apply the appropriate path finding algorithm to obtain the lowest-cost path. In MotoWavez, Dijkstra's algorithm is used, as it is optimal with a relatively low computational cost. It is also possible to apply the so-called “A-star” algorithm which employs a heuristic to improve the speed of the path finding method. Dijkstra's algorithm is the A-star algorithm with the heuristic set to zero. Dijkstra's implementation builds a predecessor tree which is used to build an inverse (weighted lowest-cost or shortest) path from each sink point to the source point. In MotoWavez, the path is reversed and passed to compute the diffraction at the points along the optimal path. The overall flow-chart of the technique is provided in FIG. 2.

Referring again to FIGS. 2-4, if additional diffraction paths are to be obtained, it is possible to eliminate the successful diffraction path from the optimization by putting infinite weights on the successful path and re-applying the algorithm. This can be done at subsequent steps, obtaining different diffraction paths at each step and improving the accuracy of the result.

In one particular enhancement, to reduce the number of points considered during the search for visibility, it is appropriate to restrict the total area to be bound by a polygon consisting only of all source points and all sink points. Specifically, the enhancement can create a convex hull defined by the entire source and sink points and can include only the edges of the 3-D database that are within the space defined by this convex hull.

In MotoWavez, the diffraction points are selected midway between the endpoints corresponding to a single edge (ρ=0.5 in equation 1). However, it is possible to assign more points, the assignment depending upon metrics such as:
1. Total length of the edge. If an edge is very long, more candidate points can be added to preserve distance (in wavelengths) approximating the same.
2. Assign diffraction points as a function of the radial distance from the source point. For example, for edges close to the antenna, assign more diffraction points (which may also be a function of the total length of the edge) while for edges far from the antenna—where the signal strength decays significantly—choose a smaller number of points.

As stated earlier, the algorithm has been implemented in Motorola's MotoWavez tool to determine the optimal diffraction path for wireless signals in a 3-D environment. However, diffraction is a problem treated in many fields and this technique can be implemented in other simulation engines that operate with diffraction phenomena. In particular, areas where diffraction phenomena are treated include optics (atmospheric, etc.), X-rays, or acoustics and as such the claimed embodiments can also be applicable in these other fields.

Thus, the technique could be treated in a generic way, whereby the metrics of the path are defined via some physical (constraining) parameter and then the optimal path with the most contribution obtained. By removing solved paths in subsequent steps, it is possible to generate independent optimal diffraction paths that can be studied, correlated, etc.

The proposed method for determining the optimal diffraction paths in a 3-D environment can be used with UTD/GTD algorithms. The method as illustrated in FIGS. 2-4 can include using a path finding algorithm and properly weighting the path between the potential diffraction points by an appropriate metric. By using the path finding algorithm with the appropriate metrics, the lowest-cost path is obtained which corresponds to the greatest diffraction contribution. The resolution of the scheme can be improved by removing previously successful paths and continuing the process.

Again, referring to FIGS. 2-4, a method (20 and method portions 30 and 40) for computing wireless signal diffraction in a three-dimensional space can include the step 22 of selecting at least a source point, finding sinkpoints at step 19 that fail to have a line-of-sight path to the source point and storing the sinkpoints found, placing diffraction points on all edges of a three-dimensional geometry at step 21, and building a visibility matrix at step 24 based on weighted paths for all source points and all sink points. The method 20 can further include the step 25 of applying a path finding algorithm on the visibility matrix for each sink point to all source points and storing at step 26 the optimal paths for each source point to all sink points if they exist. The method can further include the step of determining at decision step 23 if a last source point is selected before building the visibility matrix. The method can also include the step 27 of finding all points visible to a current source point and storing the points visible and further keeping an index to the source point where the current source point is deemed a first generation. The method at step 28 can further include picking a next point from a list of points in a current generation and determining if next picked point in the list of points is a last point at a decision step 29 and if so incrementing the current generation at step 32 of method portion 30. If a last generation is determined at decision step 34, then the method can apply weights at step 36 based on a desired metric to a path defined by a previous generation point and current generation point. If the last generation has failed to be reached at decision step 34, then the method can get a list of points from the current generation at step 38. The method can further include determining if next picked point in the list of points is a last point at decision step 29 and if not, determining if the next picked point in the list of points is in line-of-sight to a sink point at decision step 42 of method portion 40. The method can store all sink points with line of sight to the current source point at step 43 until all sink points with the path are determined. The method can also find all points visible to the current source point and store all points visible while keeping the index to the current point at step 46. The method can further apply weights at step 48 based on a desired metric to a path defined by a previous generation point and a current generation point.

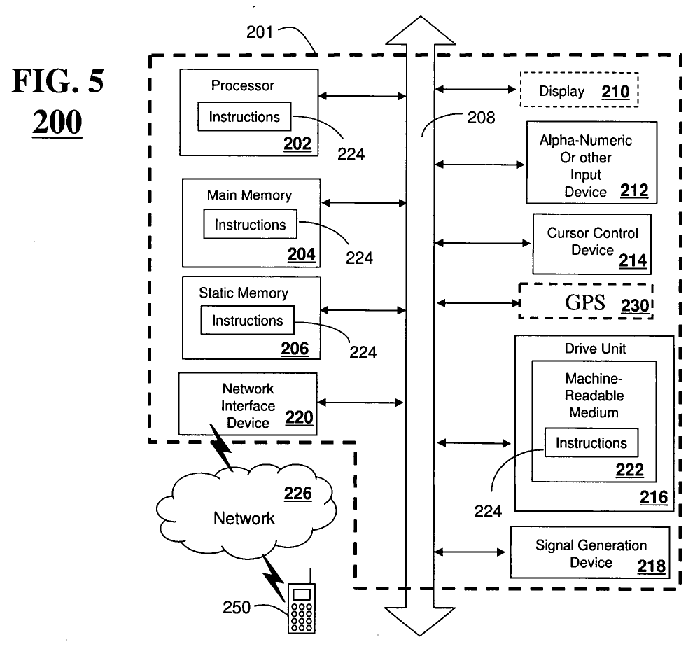

In another embodiment of the present invention as illustrated in the diagrammatic representation of FIG. 5, is a computer system 200 or electronic product 201 that can include a processor or controller 202 coupled to an optional display 210. The electronic product 201 can selectively be a wrist-worn device or a hand-held device or a fixed device. Generally, in various embodiments it can be thought of as a machine in the form of a computer system 200 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa. The computer system can further include a location finding device such as a GPS receiver 230.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such the display 210. The computer system 200 may include an input device 212 (e.g., a keyboard, microphone, etc.), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor or controller 202 during execution thereof by the computer system 200. The main memory 204 and the processor or controller 202 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for computing wireless signal diffraction in a three-dimensional space, comprising the steps of:
selecting at least a source point;
finding sinkpoints that fail to have a line-of-sight path to the source point and storing the sinkpoints found;
placing diffraction points on all edges of a three-dimensional geometry;
building a visibility matrix based on weighted paths for all source points and all sink points;
applying a path finding algorithm on the visibility matrix for each sink point to all source points; and
store optimal paths for each source point to all sink points if they exist.

2. The method of claim 1, wherein the method further comprises the step of determining if a last source point is selected before building the visibility matrix.

3. The method of claim 1, wherein the method further comprises the step of finding all points visible to a current source point and storing the points visible.

4. The method of claim 3, wherein the method further comprises the step of keeping an index to the source point where the current source point is deemed a first generation.

5. The method of claim 4, wherein the method further comprises the step of picking a next point from a list of points in a current generation.

6. The method of claim 5, wherein the method further comprises determining if next picked point in the list of points is a last point and if so incrementing the current generation.

7. The method of claim 6, wherein the method further comprises the step of applying weights based on a desired metric to a path defined by a previous generation point and current generation point if a last generation is determined.

8. The method of claim 6, wherein the method further comprises the step of getting a list of points from the current generation if the last generation has failed to be reached.

9. The method of claim 5, wherein the method further comprises determining if next picked point in the list of points is a last point and if not, determining if the next picked point in the list of points is in line-of-sight to a sink point.

10. The method of claim 9, wherein the method further comprises the step of storing all sink points with line of sight to the current source point until all sink points with the path are determined.

11. The method of claim 9, wherein the method further comprises the step of finding all points visible to the current source point and storing all points visible while keeping the index to the current point.

12. The method of claim 1, wherein the method further comprises the step of applying the Uniform Theory of Diffraction algorithm by requiring that incoming and outgoing path segments' angles with an edge be the same to filter visible but invalid diffraction paths and reduce a visibility graph size and computation times.

13. A computer program embodied in a computer storage medium and operable in a data processing machine for improving accuracy of empirical propagation models for radio frequency coverage simulations, comprising instructions executable by the data processing machine that cause the data processing machine to:
select at least a source point;
find sinkpoints that fail to have a line-of-sight path to the source point and store the sinkpoints found;
place diffraction points on all edges of a three-dimensional geometery;
build a visibility matrix based on weighted paths for all source points and all sink points;
apply a path finding algorithm on the visibility matrix for each sink point to all source points; and
store optimal paths for each source point to all sink points if they exist.

14. The computer program of claim 13, wherein the instructions further cause the data processing machine to determine if a last source point is selected before building the visibility matrix.

15. The computer program of claim 13, wherein the instructions further cause the data processing machine to find all points visible to a current source point and store the points visible.

16. The computer program of claim 15, wherein the instructions further cause the data processing machine to keep an index to the source point where the current source point is deemed a first generation and pick a next point from a list of points in a current generation.

17. The computer program of claim 16, wherein the instructions further cause the data processing machine to determine if a next picked point in the list of points is a last point and if so increment the current generation.

18. The computer program of claim 17, wherein the instructions further cause the data processing machine to apply weights based on a desired metric to a path defined by a previous generation point and current generation point if a last generation is determined

19. The computer program of claim 17, wherein the instructions further cause the data processing machine to get a list of points from the current generation if the last generation has failed to be reached.

20. The computer program of claim 13, wherein the instructions further comprises instructions that cause the data processing machine to controll a number of diffractions by limiting a maximum number of generations of points.
